(19) United States
(12) Patent Application Publication
(10) Pub. No.: US 2026/0126347 A1
(43) Pub. Date: May 7, 2026

(54) RESPONSE TIME EVALUATION METHOD

(71) Applicant: MEIDENSHA CORPORATION, Tokyo (JP)

(72) Inventor: Toshimichi TAKAHASHI, Tokyo (JP)

(21) Appl. No.: 19/484,835

(22) PCT Filed: Mar. 12, 2024
(86) PCT No.: PCT/JP2024/009479

§ 371 Date: Nov. 14, 2025

(30) Foreign Application Priority Data
May 15, 2023 (JP) 2023-080401

(51) Int. Cl. G01M 17/007

(52) U.S. Cl. CPC G01M 17/007

(57) ABSTRACT

This response time evaluation method includes: a step for acquiring time-series data x(i) of an evaluation signal output from an object being controlled when a step input signal is input to the object being controlled; a step for calculating an unbiased variance σₙ² of the time-series data x(i) over a noise sampling interval of a length N defined in a steady-state interval of the step input signal; a step for calculating sample variance and moving average time-series data σₙₚ²(i), xₘₐ(i) of the time series data x(i) over a smoothing interval of a length NP centered at discrete time points i; a step for calculating time-series data y(i) of a smoothed signal on the basis of the time-series data σₙₚ²(i), xₘₐ(i); and a step for calculating the response time of the evaluation signal on the basis of the time-series data y(i).

### TECHNICAL FIELD

The present invention relates to a response time evaluation method. More specifically, the present invention relates to a response time evaluation method for evaluating a response time of an evaluation signal output from a control target or a dynamometer system.

### BACKGROUND ART

A chassis dynamometer system is used in tests for measuring and evaluating, for example, a power consumption rate, a fuel consumption rate, and exhaust emission purification performance of a vehicle. The chassis dynamometer system includes rollers configured to receive wheels of the vehicle to be tested, and a dynamometer connected to the rollers. Conditions close to actual running conditions are reproduced by applying, to the vehicle running on the rollers, running resistances such as rolling resistance and inertial resistance, which occur during actual running, using the dynamometer and the rollers.

In such a test using the chassis dynamometer system, in order to guarantee measurement results and evaluation results obtained in the test, it is also necessary to evaluate whether a response time of the dynamometer is appropriate. The response time is often calculated by inputting, to the control target, an input signal having a stepwise change, and measuring a change in a predetermined evaluation signal output from the control target.

### CITATION LIST

### Patent Document

Patent Document 1: Japanese Unexamined Patent Application, Publication No. 2022-148844

### DISCLOSURE OF THE INVENTION

### Problems to be Solved by the Invention

In many cases, the evaluation signal output from a sensor includes noise. Therefore, in the technique disclosed in Patent Document 1, median filter processing is applied to time-series data of the evaluation signal, thereby removing noise contained in the original evaluation signal while avoiding causing a delay in a rise of the evaluation signal. More specifically, in the technique disclosed in Patent Document 1, a time width of the median filter is optimized such that a signal after the median filter processing falls within a range between a predetermined upper limit and a predetermined lower limit.

Accordingly, according to the technique disclosed in Patent Document 1, if the S/N ratio of the evaluation signal is large, the response time of the evaluation signal can be calculated with high accuracy. However, if the S/N ratio becomes small, the median filter processing may cause excessive smoothing, and the response time may not be calculated with high accuracy.

An object of the present invention is to provide a response time evaluation method capable of evaluating the response time of the evaluation signal with high accuracy by executing processing based on a magnitude of noise contained in the original evaluation signal.

### Means for Solving the Problems

(1) A response time evaluation method according to the present invention is a response time evaluation method for an evaluation signal output from a control target, in which the method includes the steps of: (A) acquiring time-series data x(i) of the evaluation signal output from the control target when a step input signal having a stepwise change is input to the control target, where i is a parameter indicating discrete time; (B) calculating a variance σₙ² of the time-series data x(i) over a noise sample section defined within a steady section of the step input signal; (C) calculating, over a smoothing section having a length equal to or less than the noise sample section and centered at the discrete time i, time-series data σₙₚ²(i) of a variance of the time-series data x(i), time-series data xₘₐ(i) of a moving average, and time-series data y(i) of a smoothed signal defined by Formula (1); and (D) calculating the response time of the evaluation signal based on the time-series data y(i).

$$[ Math . 1 ]$$

$$y ( i ) = \frac{{σ}_{np}^{2} ( i ) - {σ}_{n}^{2}}{{σ}_{np}^{2} ( i )} \{ x ( i ) - {x}_{ma} ( i ) \} + {x}_{ma} ( i ) \qquad ( 1 )$$

(2) In this case, in the step (D), it is preferable to calculate, as the response time, a time from a rise time of the step input signal to a time when the time-series data y(i) exceeds a threshold determined based on the step input signal.

(3) In this case, it is preferable that the steady section be a section before or after the step input signal changes stepwise.

(4) In this case, it is preferable that the control target include a rotating body that rotates in response to the input signal.

(5) In this case, in the step (C), it is preferable to optimize a smoothing section length, which is a length of the smoothing section, such that a peak value σₚₑₐₖ² of the time-series data σₙₚ²(i) in the steady section falls within a variance setting range determined to include the variance σₙ².

(6) In this case, in the step (C), it is preferable to optimize a smoothing section length, which is a length of the smoothing section, such that a peak value σₚₑₐₖ² of the time-series data σₙₚ²(i) in the steady section falls within a variance setting range determined to include the variance σₙ², and that the time-series data y(i) in the steady section falls within a signal setting range determined to include a command value corresponding to the step input signal.

(7) A response time evaluation method according to the present invention is a method for evaluating the response time of the evaluation signal in a dynamometer system including a dynamometer, an inverter configured to supply electric power in response to an input signal to the dynamometer, and an evaluation signal output unit configured to output the evaluation signal in accordance with a speed or torque of the dynamometer, in which the method includes: (A) acquiring time-series data x(i) (where i is a parameter indicating discrete time) of the evaluation signal output from the sensor when a step input signal having a stepwise change is input to the inverter; (B) calculating a variance σₙ² of the time-series data x(i) over a noise sample section defined within a steady section of the step input signal; (C) calculating, over a smoothing section having a length equal to or less than the noise sample section and centered at the discrete time i, time-series data σₙₚ²(i) of a variance of the time-series data x(i), time-series data xₘₐ(i) of a moving average, and time-series data y(i) of a smoothed signal defined by Formula (2); and (D) calculating the response time of the evaluation signal based on the time-series data y(i).

$$[ Math . 2 ]$$

$$y ( i ) = \frac{{σ}_{np}^{2} ( i ) - {σ}_{n}^{2}}{{σ}_{np}^{2} ( i )} \{ x ( i ) - {x}_{ma} ( i ) \} + {x}_{ma} ( i ) \qquad ( 2 )$$

### Effects of the Invention

(1) In the present invention, based on the time-series data x(i) of the evaluation signal, a variance σₙ² of the time-series data x(i) over a noise sample section defined within a steady section of a step input signal, and time-series data σₙₚ²(i) of a variance of the time-series data x(i) over a smoothing section having a length equal to or less than the noise sample section and centered at the discrete time i, and time-series data xₘₐ(i) of a moving average, are calculated. In the present invention, time-series data y(i) of a smoothed signal obtained by smoothing the evaluation signal based on the above Formula (1) is calculated, and further, a response time of the original evaluation signal is calculated based on the time-series data y(i). Here, according to the above Formula (1), when a change of the evaluation signal is small in the smoothing section centered at the discrete time i, that is, when most of variation components of the evaluation signal are noise, σₙₚ²(i)≈σₙ², so that y(i)≈xₘₐ(i). That is, in a smoothing section in which the change of the evaluation signal is small, noise contained in the original evaluation signal can be removed, and smooth time-series data y(i) can be obtained. On the other hand, when a change of the evaluation signal is large in the smoothing section centered at the discrete time i, that is, when the evaluation signal changes stepwise, σₙₚ²(i)>σₙ², so that y(i)≈x(i). That is, in a smoothing section in which the change of the evaluation signal is large, time-series data y(i) substantially equal to the original time-series data x(i) can be obtained. Therefore, according to the present invention, when generating the time-series data y(i) of the smoothed signal from the time-series data x(i) of the original evaluation signal, the variation caused by noise in the steady section can be smoothed, and in a section in which the time-series data x(i) changes stepwise, no delay due to the smoothing processing occurs, so that the response time of the evaluation signal can be calculated with high accuracy.

(2) In the present invention, a time from a rise time of the step input signal to a time when the time-series data y(i) of the smoothed signal exceeds a threshold determined based on the step input signal is calculated as the response time. This makes it possible to calculate the response time of the evaluation signal to the step input signal in the control target with high accuracy.

(3) In the present invention, a section before or after the step input signal changes stepwise, that is, a section in which most of variation components of the evaluation signal are noise, is defined as the steady section, and the noise sample section is defined within the steady section, and the variance σₙ² of the time-series data x(i) is calculated. This makes it possible to execute appropriate smoothing processing (that is, the processing based on the above Formula (1)) based on a magnitude of noise contained in the evaluation signal.

(4) In the present invention, it is possible to calculate with high accuracy the response time of the evaluation signal to the step input signal in the control target including a rotating body.

(5) In the present invention, a smoothing section length, which is a length of the smoothing section, is optimized such that a peak value σₚₑₐₖ² of the time-series data σₙₚ²(i) in the steady section falls within a variance setting range determined to include the variance σₙ². Therefore, according to the present invention, the smoothing section length can be set to a length corresponding to a magnitude of noise contained in the evaluation signal.

(6) In the present invention, a smoothing section length, which is a length of the smoothing section, is optimized such that a peak value σₚₑₐₖ² of the time-series data σₙₚ²(i) in the steady section falls within a variance setting range determined to include the variance σₙ², and that the time-series data y(i) in the steady section falls within a signal setting range determined to include a command value corresponding to the step input signal. Therefore, according to the present invention, the smoothing section length can be set to a minimum necessary length while keeping the variation of the time-series data y(i) in the steady section within the signal setting range, and as a result, the response time can be evaluated with high accuracy.

(7) According to the present invention, for the same reason as in the invention (1) above, the response time of the evaluation signal in the dynamometer system can be evaluated (that is, calculated) with high accuracy.

### BRIEF DESCRIPTION OF THE DRAWINGS

FIG. 1 is a diagram illustrating a configuration of a chassis dynamometer system, to which a response time evaluation method according to a first embodiment of the present invention is applied;

FIG. 2A is a flowchart illustrating specific procedures of a response time evaluation processing according to the embodiment (part 1);

FIG. 2B is a flowchart illustrating specific procedures of the response time evaluation processing according to the embodiment (part 2);

FIG. 3 is a time chart for explaining procedures of the response time evaluation processing according to the embodiment;

FIG. 4A is a flowchart illustrating specific procedures of a response time evaluation processing according to a second embodiment of the present invention (part 1);

FIG. 4B is a flowchart illustrating specific procedures of the response time evaluation processing according to the embodiment (part 2); and

FIG. 5 is a time chart for explaining procedures of the response time evaluation processing according to the embodiment.

### PREFERRED MODE FOR CARRYING OUT THE INVENTION

### First Embodiment

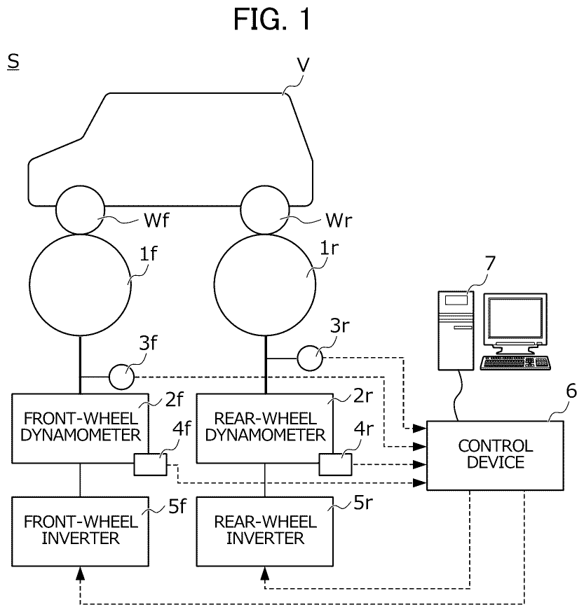

Hereinafter, a first embodiment of the present invention will be described with reference to the drawings. FIG. 1 is a diagram illustrating a configuration of a chassis dynamometer system S, to which a response time evaluation method according to the present embodiment is applied, and a test vehicle V thereof (hereinafter simply referred to as “vehicle V”).

In the following description, the vehicle V will be described as a four-wheel drive (4WD) vehicle that transmits power to front wheels Wf and rear wheels Wr separately; however, the present invention is not limited thereto. The vehicle V may be a front-wheel drive (FWD) vehicle or a rear-wheel drive (RWD) vehicle.

The chassis dynamometer system S includes: front-wheel rollers 1f and rear-wheel rollers 1r configured to receive the front wheels Wf and the rear wheels Wr of the vehicle V, respectively, and to rotate in synchronism with rotation of the wheels; front-wheel dynamometers 2f and rear-wheel dynamometers 2r coaxially connected to the rollers 1f and 1r, respectively; front-wheel speed sensors 3f and rear-wheel speed sensors 3r configured to detect a rotational speed of the dynamometers 2f and 2r or the rollers 1f and 1r, respectively; front-wheel torque sensors 4f and rear-wheel torque sensors 4r configured to detect a torque applied to the dynamometers 2f and 2r, respectively; front-wheel inverters 5f and rear-wheel inverters 5r configured to supply electric power to the dynamometers 2f and 2r, respectively; a control device 6 configured to control the dynamometers 2f and 2r by operating the inverters 5f and 5r; and an operation measurement system 7 connected to the control device 6.

The control device 6 executes speed control and running resistance control of the dynamometers 2f and 2r, based on detection signals transmitted from the speed sensors 3f and 3r, the torque sensors 4f and 4r, and command signals transmitted from the operation measurement system 7 described later.

The operation measurement system 7 is a computer including: an operation acceptance function configured to accept various operations by an operator of the chassis dynamometer system S; a communication function configured to transmit and receive various information to and from the control device 6; a calculation function configured to execute calculation based on information obtained through the operation acceptance function and the communication function; and a display function configured to display, in a form recognizable by the operator, information obtained through the calculation function and the communication function.

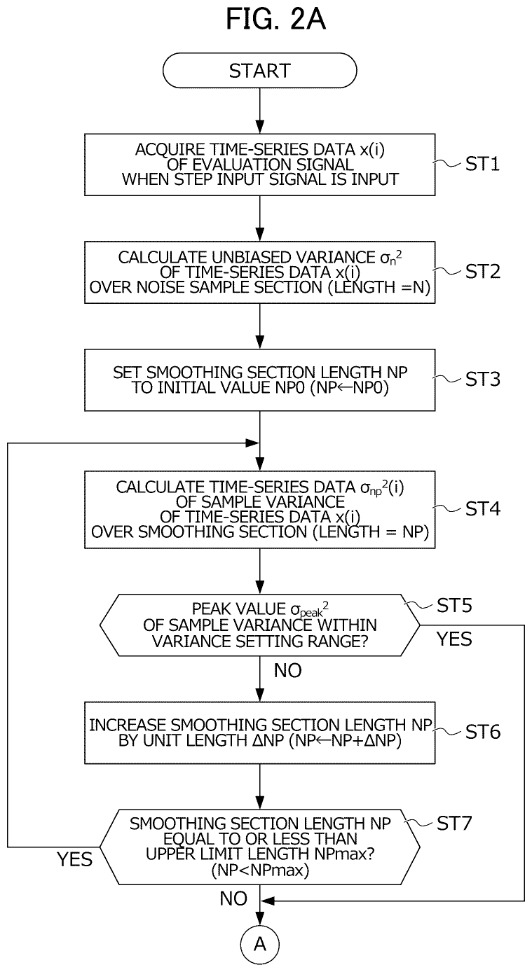

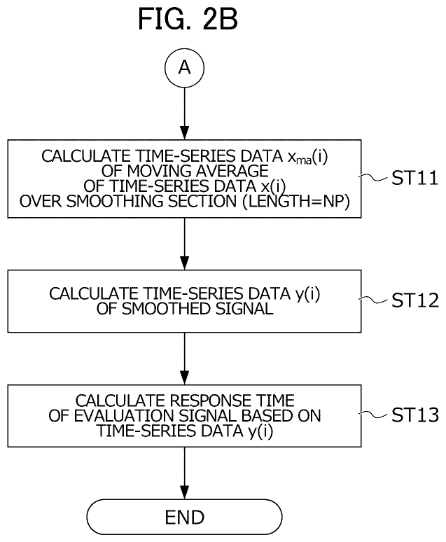

FIGS. 2A and 2B are flowcharts illustrating specific procedures of a response time evaluation processing executed by the operation measurement system 7. This response time evaluation processing targets the above-described dynamometer system S as a control target, and evaluates a response time of an evaluation signal output from the control target when an input signal is input to the control target.

In the following description, a case will be explained in which, in the above-described dynamometer system S, a front-wheel control system including the front-wheel dynamometer 2f, the front-wheel speed sensor 3f, the front-wheel torque sensor 4f, and the front-wheel inverter 5f is used as the control target, a torque current command signal input to the front-wheel inverter 5f is used as the input signal, and a signal obtained by applying predetermined processing to a speed detection signal output from the front-wheel speed sensor 3f (for example, an acceleration/deceleration signal obtained by differentiating the speed detection signal) is used as the evaluation signal, and the response time of the evaluation signal is evaluated; however, the present invention is not limited thereto. In such a front-wheel control system of the dynamometer system S, a torque detection signal output from the front-wheel torque sensor 4f, or a signal generated based on at least one of the speed detection signal and the torque detection signal (for example, the speed detection signal itself, or a driving force signal obtained through calculation using the speed detection signal and the torque detection signal) may be used as the evaluation signal.

The present invention can also be applied to a case in which a rear-wheel control system including the rear-wheel dynamometer 2r, the rear-wheel speed sensor 3r, the rear-wheel torque sensor 4r, and the rear-wheel inverter 5r is used as the control target, a torque current command signal input to the rear-wheel inverter 5r is used as the input signal, and a signal obtained by applying predetermined processing to a speed detection signal output from the rear-wheel speed sensor 3r (for example, an acceleration/deceleration signal obtained by differentiating the speed detection signal) is used as the evaluation signal, and the response time of the evaluation signal is evaluated. In this case, similarly to the front-wheel control system, a torque detection signal output from the rear-wheel torque sensor 4r, or a signal generated based on at least one of the speed detection signal and the torque detection signal (for example, the speed detection signal itself, or a driving force signal obtained through calculation using the speed detection signal and the torque detection signal) may be used as the evaluation signal.

In the following description, a case will be explained in which the operation measurement system 7 starts the response time evaluation processing illustrated in FIGS. 2A and 2B in response to accepting a predetermined start operation by the operator; however, the present invention is not limited thereto. The response time evaluation processing illustrated in FIGS. 2A and 2B may also be automatically started by the operation measurement system 7 during, before, or after operation of a vehicle test on the vehicle under control of the control device. In this case, the result of the response time evaluation processing can be stored in a storage medium (not illustrated) in association with the result of the test on the vehicle, or can be reported to the operator.

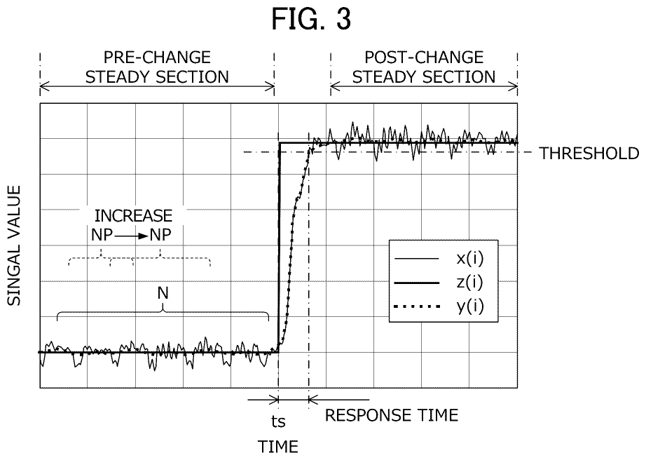

FIG. 3 is a time chart for explaining procedures of the response time evaluation processing. Hereinafter, specific procedures of the response time evaluation processing illustrated in FIGS. 2A and 2B will be described with reference to the time chart of FIG. 3.

First, in Step ST1, when a step input signal having a stepwise change is input to the control target, the operation measurement system 7 acquires time-series data x(i) (where i is an integer parameter indicating discrete time) of the evaluation signal output from the control target, under a predetermined sampling period. More specifically, the operation measurement system 7 inputs the step input signal to the front-wheel inverter 5r via the control device 6, and at the same time acquires the time-series data x(i) of the evaluation signal generated based on the speed detection signal output from the front-wheel speed sensor 2f at that time. In FIG. 3, the time-series data z(i) of the step input signal is indicated by a thick solid line, and the time-series data x(i) of the evaluation signal is indicated by a thin solid line.

Next, in Step ST2, the operation measurement system 7 defines a noise sample section having a predetermined length within the steady section of the step input signal, and calculates, based on the time-series data x(i) acquired in Step ST1, an unbiased variance σₙ² of the time-series data x(i) over the noise sample section, and proceeds to Step ST3. In the following description, a noise sample section length, which is a length of the noise sample section, is represented by an integer value “N” corresponding to the number of data of the time-series data x(i) contained in the noise sample section.

Here, the steady section of the step input signal is a section in which the time-series data z(i) of the step input signal is substantially constant, and, as illustrated in FIG. 3, is divided into a pre-change steady section before a time ts at which the step input signal changes stepwise, and a post-change steady section after the time ts. As illustrated in FIG. 3, since the time-series data x(i) of the evaluation signal starts to rise with a predetermined delay from the time ts, a start time of the post-change steady section is set to a predetermined time after the time ts.

In the following description, a case will be explained in which the noise sample section for calculating the unbiased variance σₙ² is set in the pre-change steady section as illustrated in FIG. 3; however, the present invention is not limited thereto. The noise sample section may be set in the post-change steady section, not limited to the pre-change steady section.

The noise sample section is set to as wide a range as possible within the steady section. Therefore, the noise sample section length N is set to be slightly shorter than, for example, a length of the steady section.

Next, in Step ST3, the operation measurement system 7 sets a smoothing section length NP, which is a length of a smoothing section described later, to an initial value NP0 (NP←NP0). Here, the initial value NP0 is any integer value; however, is preferably set to a value sufficiently smaller than the above noise sample section length N (N>NP0).

Next, in Step ST4, the operation measurement system 7 defines a smoothing section having a range of a smoothing section length NP centered at the discrete time i, and calculates time-series data σₙₚ²(i) of a sample variance of the time-series data x(i) over the smoothing section, and proceeds to Step ST5.

Next, in Step ST5, the operation measurement system 7 determines whether a peak value σₚₑₐₖ² of the time-series data σₙₚ²(i) of the sample variance calculated in Step ST4, within the steady section (more specifically, the same steady section in which the noise sample section is defined in Step ST2, and, in the example of FIG. 3, within the pre-change steady section), falls within a variance setting range determined to include the unbiased variance σₙ². Here, the variance setting range is more specifically defined by Formula (3). In Formula (3), “Lower” and “Upper” are arbitrary values each slightly greater than 0.

$$[ Math . 3 ]$$

$${σ}_{n}^{2} \frac{100 - Lower}{100} < {σ}_{peak}^{2} < {σ}_{r ι}^{2} \frac{100 + Upper}{100} \qquad ( 3 )$$

If the determination result in Step ST5 is NO, the operation measurement system 7 proceeds to Step ST6, and if YES, proceeds to Step ST11 (see FIG. 2B).

Next, in Step ST6, the operation measurement system 7 increases the smoothing section length NP by a predetermined unit length ΔNP, and then proceeds to Step ST7 (NP←NP+ΔNP). Here, the value of the unit length ΔNP is an arbitrary integer greater than 0; however, is set to as small a value as possible, for example, “1”.

Next, in Step ST7, the operation measurement system 7 determines whether the current smoothing section length NP is equal to or less than a predetermined upper limit length NPmax. In the following description, a case will be explained in which the upper limit length NPmax is made equal to the noise sample section length N (NPmax=N); however, the present invention is not limited thereto. The upper limit length NPmax is set within a range greater than the initial value NP0 and equal to or less than the noise sample section length N. If the determination result in Step ST7 is YES, the operation measurement system 7 returns to Step ST4, recalculates the time-series data σₙₚ²(i) of the sample variance under the changed smoothing section, and if NO, proceeds to Step ST11 (see FIG. 2B).

As described above, the operation measurement system 7 increases the smoothing section length NP from the initial value by the unit length ΔNP until the peak value σₚₑₐₖ² of the time-series data σₙₚ²(i) of the sample variance in the steady section falls within the variance setting range illustrated in the above Formula (3) (see Step ST5), or until the smoothing section length NP reaches the upper limit length NPmax (see Step ST7). That is, the operation measurement system 7 optimizes the smoothing section length NP so that the peak value σₚₑₐₖ² falls within the variance setting range, by repeatedly executing the processing of Steps ST4 to ST7.

Next, in Step ST11, the operation measurement system 7 calculates time-series data xₘₐ(i) of a moving average of the time-series data x(i) over the smoothing section optimized through the above procedure, and proceeds to Step ST12.

Next, in Step ST12, the operation measurement system 7 calculates, using Formula (4) using the unbiased variance σₙ² calculated in Step ST2, the time-series data σₙₚ²(i) and xₘₐ(i) calculated under the optimized smoothing section, time-series data y(i) of a smoothed signal obtained by smoothing the original evaluation signal, and proceeds to Step ST13.

$$[ Math . 4 ]$$

$$y ( i ) = \frac{{σ}_{np}^{2} ( i ) - {σ}_{n}^{2}}{{σ}_{np}^{2} ( i )} \{ x ( i ) - {x}_{ma} ( i ) \} + {x}_{ma} ( i ) \qquad ( 4 )$$

In FIG. 3, the time-series data y(i) of the smoothed signal calculated through the above procedure is indicated by a thick broken line. According to the above Formula (4), when variation of the evaluation signal is small in the smoothing section centered at the discrete time i, that is, when most of variation components of the evaluation signal are noise, σₙₚ²(i)≈σₙ², so that y(i)≈xₘₐ(i). That is, in a section in which the change of the evaluation signal is small (that is, in sections excluding a vicinity of the time ts in FIG. 3), noise contained in the original evaluation signal can be removed, and smooth time-series data y(i) can be obtained. On the other hand, when the change of the evaluation signal is large in the smoothing section centered at the discrete time i, that is, when the evaluation signal changes stepwise, σₙₚ²(i)>σₙ², so that y(i)≈x(i). That is, in a section in which the change of the evaluation signal is large (that is, in the section near the time ts in FIG. 3), time-series data y(i) substantially equal to the original time-series data x(i) can be obtained. Therefore, according to the present embodiment, when generating the time-series data y(i) of the smoothed signal from the time-series data x(i) of the original evaluation signal, the variation caused by noise in the steady section can be smoothed, and in a section in which the time-series data x(i) changes stepwise, no delay due to the smoothing processing occurs.

Next, in Step ST13, the operation measurement system 7 calculates the response time of the original evaluation signal based on the time-series data y(i) of the smoothed signal calculated in Step ST12, and ends the response time evaluation processing illustrated in FIGS. 2A and 2B. More specifically, the operation measurement system 7 calculates, as the response time, a time from a rise time of the step input signal (in FIG. 3, the time ts) to a time when the time-series data y(i) of the smoothed signal exceeds a threshold determined based on the step input signal.

According to the response time evaluation method of the present embodiment, the following effects can be achieved.

(1) In the present embodiment, based on the time-series data x(i) of the evaluation signal, the unbiased variance σₙ² of the time-series data x(i) over the noise sample section defined within the steady section of the step input signal, the time-series data σₙₚ²(i) of the sample variance of the time-series data x(i) over the smoothing section having a length equal to or less than the noise sample section and centered at the discrete time i, and the time-series data xₘₐ(i) of a moving average are calculated. In the present embodiment, the time-series data y(i) of the smoothed signal obtained by smoothing the evaluation signal based on the above Formula (4) is calculated, and further, the response time of the original evaluation signal is calculated based on the time-series data y(i). Therefore, according to the present embodiment, when generating the time-series data y(i) of the smoothed signal from the time-series data x(i) of the original evaluation signal, the variation caused by noise in the steady section can be smoothed, and in a section in which the time-series data x(i) changes stepwise, no delay due to the smoothing processing occurs, so that the response time of the evaluation signal can be calculated with high accuracy.

(2) In the present embodiment, a time from a rise time of the step input signal to a time when the time-series data y(i) of the smoothed signal exceeds a threshold determined based on the step input signal is calculated as the response time. This makes it possible to calculate the response time of the evaluation signal to the step input signal in the control target with high accuracy.

(3) In the present embodiment, a section before or after the step input signal changes stepwise, that is, a section in which most of variation components of the evaluation signal are noise, is defined as the steady section, and the noise sample section is defined within the steady section, and the unbiased variance σₙ² of the time-series data x(i) is calculated. This makes it possible to execute appropriate smoothing processing (that is, the processing based on the above Formula (4)) based on a magnitude of noise contained in the evaluation signal.

(4) In the present embodiment, the smoothing section length NP is optimized such that the peak value σₚₑₐₖ² of the time-series data σₙₚ²(i) of the sample variance in the steady section falls within the variance setting range determined to include the unbiased variance σₙ². Therefore, according to the present embodiment, the smoothing section length NP can be set to a length corresponding to a magnitude of noise contained in the evaluation signal.

(5) According to the present embodiment, the response time of the dynamometer system can be automatically evaluated not only at the time of maintenance of the dynamometer system; however, also during, before, or after operation of a vehicle test, as long as the dynamometer is under control, thereby improving user convenience.

### Second Embodiment

Hereinafter, a second embodiment of the present invention will be described with reference to the drawings. Since a mechanical configuration of a chassis dynamometer system according to the present embodiment is the same as that of the chassis dynamometer system S according to the first embodiment, illustration and detailed description thereof are omitted. The chassis dynamometer system according to the present embodiment differs from the chassis dynamometer system S according to the first embodiment in procedures of a response time evaluation processing in the operation measurement system 7.

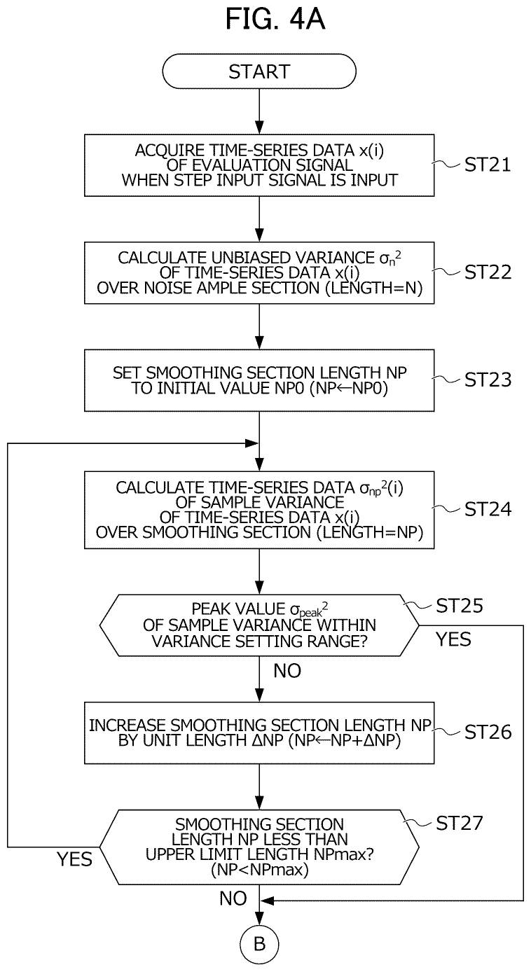

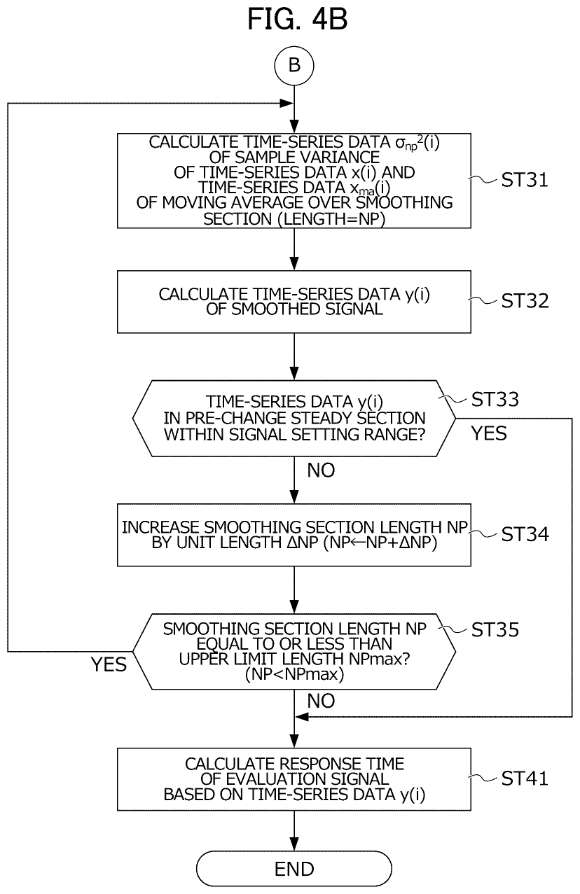

FIGS. 4A and 4B are flowcharts illustrating specific procedures of the response time evaluation processing executed by the operation measurement system 7 according to the present embodiment. In the following description, similarly to the first embodiment, a case will be explained in which a front-wheel control system is used as a control target, a torque current command signal input to the front-wheel inverter is used as an input signal, and a signal obtained by applying predetermined processing to a speed detection signal output from the front-wheel speed sensor (for example, an acceleration/deceleration signal obtained by differentiating the speed detection signal) is used as an evaluation signal, and a response time of the evaluation signal is evaluated; however, the present invention is not limited thereto. Control targets, evaluation signals, and the like can be modified similarly to the first embodiment.

In the following description, a case will be explained in which the operation measurement system 7 starts the response time evaluation processing illustrated in FIGS. 4A and 4B in response to accepting a predetermined start operation by an operator, similarly to the first embodiment; however, the present invention is not limited thereto. The response time evaluation processing illustrated in FIGS. 4A and 4B may also be automatically started by the operation measurement system 7 during, before, or after operation of a vehicle test on the vehicle under control of the control device, similarly to the first embodiment.

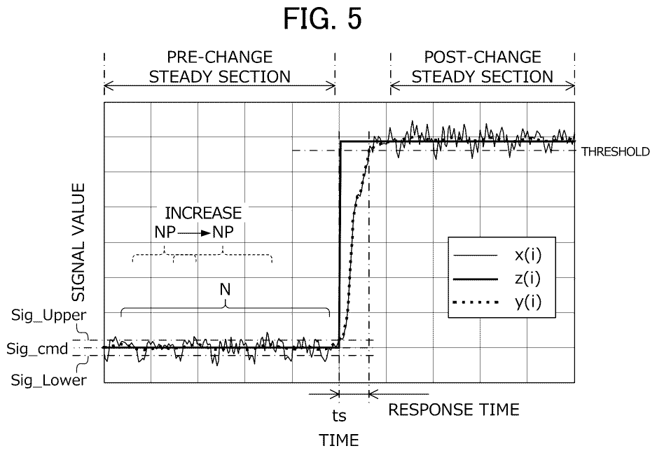

FIG. 5 is a time chart for explaining procedures of the response time evaluation processing based on the present embodiment. Hereinafter, specific procedures of the response time evaluation processing illustrated in FIGS. 4A and 4B will be described with reference to the time chart of FIG. 5.

Processing illustrated in Steps ST21 to ST27 in FIG. 4A are the same as that illustrated in Steps ST1 to ST7 in FIG. 2A, and therefore, detailed description thereof is omitted below. That is, the operation measurement system 7 repeatedly executes the processing of Steps ST24 to ST27, thereby adjusting the smoothing section length NP so that a peak value σₚₑₐₖ² falls within the variance setting range illustrated in the above Formula (3), and then proceeds to Step ST31 (see FIG. 4B).

In Step ST31, the operation measurement system 7 defines a smoothing section having a range of the smoothing section length NP centered at the discrete time i, and calculates time-series data σₙₚ²(i) of a sample variance of the time-series data x(i) over the smoothing section, and time-series data xₘₐ(i) of a moving average over the smoothing section, and proceeds to Step ST32.

Next, in Step ST32, the operation measurement system 7 calculates, using the above Formula (4), time-series data y(i) of a smoothed signal obtained by smoothing the original evaluation signal, using the unbiased variance σₙ² calculated in Step ST22 and the time-series data σₙₚ²(i) and xₘₐ(i) calculated in Step ST31, and proceeds to Step ST33.

Next, in Step ST33, the operation measurement system 7 determines whether the time-series data y(i) calculated in Step ST32, within the pre-change steady section, falls within a signal setting range determined to include a command value Sig_cmd corresponding to the step input signal. Here, the signal setting range is more specifically defined by Formula (5). In Formula (5), “Sig_Lower” is set to a value slightly smaller than the command value Sig_cmd, and “Sig_Upper” is set to a value slightly greater than the command value Sig_cmd.

$$[ Math . 5 ]$$

$$Sig\_lower < y ( i ) < Sig\_Upper \qquad ( 5 )$$

In the present embodiment, a case will be explained in which a determination is made as to whether the time-series data y(i) falls within the signal setting range only in the pre-change steady section among the two steady sections; however, the present invention is not limited thereto. A determination may be made as to whether the time-series data y(i) falls within the signal setting range only in the post-change steady section, or in both the pre-change steady section and the post-change steady section.

If the determination result in Step ST33 is NO, the operation measurement system 7 proceeds to Step ST34, and if YES, proceeds to Step ST41.

Next, in Step ST34, the operation measurement system 7 increases the smoothing section length NP by a predetermined unit length ΔNP, and then proceeds to Step ST35 (NP←NP+ΔNP).

Next, in Step ST35, the operation measurement system 7 determines whether the current smoothing section length NP is equal to or less than the upper limit length NPmax. If the determination result in Step ST35 is YES, the operation measurement system 7 returns to Step ST31, recalculates the time-series data σₙₚ²(i), xₘₐ(i), and y(i) under the changed smoothing section, and if NO, proceeds to Step ST41.

As described above, in the present embodiment, the operation measurement system 7 increases the smoothing section length NP from the initial value by the unit length ΔNP until the peak value σₚₑₐₖ² of the time-series data σₙₚ²(i) of the sample variance in the steady section falls within the variance setting range illustrated in Formula (3) (see Step ST25), or until the smoothing section length NP reaches the upper limit length NPmax (see Step ST27), and then further increases the smoothing section length NP by the unit length ΔNP until the time-series data y(i) in the steady section falls within the signal setting range illustrated in Formula (5) (see Step ST33), or until the smoothing section length NP reaches the upper limit length NPmax (see Step ST35). That is, the operation measurement system 7 optimizes the smoothing section length NP by repeatedly executing the processing of Steps ST24 to ST27 and the processing of Steps ST31 to ST35, so that the peak value σₚₑₐₖ² falls within the variance setting range, and that the time-series data y(i) in the steady section falls within the signal setting range.

Next, in Step ST41, the operation measurement system 7 calculates the response time of the original evaluation signal in accordance with the same procedure as in the first embodiment, based on the time-series data y(i) of the smoothed signal calculated under the optimized smoothing section as described above, and ends the response time evaluation processing illustrated in FIGS. 4A and 4B.

According to the response time evaluation method of the present embodiment, in addition to the effects (1) to (3) and (5) described above, the following effect can be achieved.

(6) In the present embodiment, the smoothing section length NP is optimized such that the peak value σₚₑₐₖ² of the time-series data σₙₚ²(i) of the sample variance in the steady section falls within the variance setting range determined to include the unbiased variance σₙ², and that the time-series data y(i) in the steady section falls within the signal setting range determined to include the command value corresponding to the step input signal. Therefore, according to the present embodiment, the smoothing section length NP can be set to a minimum necessary length while keeping the variation of the time-series data y(i) in the steady section within the signal setting range, and as a result, the response time can be evaluated with high accuracy.

Although one embodiment of the present invention has been described above, the present invention is not limited thereto. Details of the configuration may be appropriately modified within the scope of the spirit of the present invention.

For example, in the above embodiment, a case has been described in which the response time evaluation method is applied to a chassis dynamometer system; however, the present invention is not limited thereto. The present invention can be applied not only to a chassis dynamometer system; however, also to a dynamometer system such as an engine bench system or a drive-train bench system, and to a control target including a rotating body such as a dynamometer or an electric rotating machine.

### EXPLANATION OF REFERENCE NUMERALS

S: chassis dynamometer system (dynamometer system)
1f, 1r: roller
2f, 2r: dynamometer
3f, 3r: speed sensor
4f, 4r: torque sensor
5f, 5r: inverter
6: control device
7: operation measurement system
V: vehicle

1. A response time evaluation method for an evaluation signal output from a control target, the method comprising the steps of:
(A) acquiring time-series data x(i) of the evaluation signal output from the control target when a step input signal having a stepwise change is input to the control target, where i is a parameter indicating discrete time;
(B) calculating a variance σₙ² of the time-series data x(i) over a noise sample section defined within a steady section of the step input signal;
(C) calculating, over a smoothing section having a length equal to or less than the noise sample section and centered at the discrete time i, time-series data σₙₚ²(i) of a variance of the time-series data x(i), time-series data xₘₐ(i) of a moving average, and time-series data y(i) of a smoothed signal defined by Formula (1); and
(D) calculating a response time of the evaluation signal based on the time-series data y(i), wherein, in the step (C), a smoothing section length, which is a length of the smoothing section, is optimized such that a peak value σₚₑₐₖ² of the time-series data σₙₚ²(i) in the steady section falls within a variance setting range determined to include the variance σₙ².
$$[ Math . 1 ]$$
$$y ( i ) = \frac{{σ}_{np}^{2} ( i ) - {σ}_{n}^{2}}{{σ}_{np}^{2} ( i )} \{ x ( i ) - {x}_{ma} ( i ) \} + {x}_{ma} ( i ) \qquad ( 1 )$$

2. The response time evaluation method according to claim 1, wherein, in the step (D), a time from a rise time of the step input signal to a time when the time-series data y(i) exceeds a threshold determined based on the step input signal is calculated as the response time.

3. The response time evaluation method according to claim 1, wherein the steady section is a section before or after the step input signal changes stepwise.

4. The response time evaluation method according to claim 1, wherein the control target includes a rotating body that rotates in response to the input signal.

5. (canceled)

6. The response time evaluation method according to claim 1, wherein, in the step (C), a smoothing section length, which is a length of the smoothing section, is optimized such that the peak value σₚₑₐₖ² of the time-series data σₙₚ²(i) in the steady section falls within the variance setting range determined to include the variance σₙ², and that the time-series data y(i) in the steady section falls within a signal setting range determined to include a command value corresponding to the step input signal.

7. A response time evaluation method for an evaluation signal in a dynamometer system including a dynamometer,
an inverter configured to supply electric power in response an input signal to the dynamometer, and
an evaluation signal output unit configured to output the evaluation signal in accordance with a speed or torque of the dynamometer, the method comprising the steps of:
(A) acquiring time-series data x(i) of the evaluation signal output from the sensor evaluation signal output unit when a step input signal having a stepwise change is input to the inverter, where i is a parameter indicating discrete time;
(B) calculating a variance σₙ² of the time-series data x(i) over a noise sample section defined within a steady section of the step input signal;
(C) calculating, over a smoothing section having a length equal to or less than the noise sample section and centered at the discrete time i, time-series data σₙₚ²(i) of a variance of the time-series data x(i), time-series data xₘₐ(i) of a moving average, and time-series data y(i) of a smoothed signal defined by Formula (2); and
(D) calculating the response time of the evaluation signal based on the time-series data y(i),
wherein, in the step (C), a smoothing section length, which is a length of the smoothing section, is optimized such that a peak value σₚₑₐₖ² of the time-series data σₙₚ²(i) in the steady section falls within a variance setting range determined to include the variance σₙ².
$$[ Math . 2 ]$$
$$y ( i ) = \frac{{σ}_{np}^{2} ( i ) - {σ}_{n}^{2}}{{σ}_{np}^{2} ( i )} \{ x ( i ) - {x}_{ma} ( i ) \} + {x}_{ma} ( i ) \qquad ( 2 )$$

8. The response time evaluation method according to claim 2, wherein, in the step (C), a smoothing section length, which is a length of the smoothing section, is optimized such that the peak value σₚₑₐₖ² falls within the variance setting range, and that the time-series data y(i) in the steady section falls within a signal setting range determined to include a command value corresponding to the step input signal.

9. The response time evaluation method according to claim 3, wherein, in the step (C), a smoothing section length, which is a length of the smoothing section, is optimized such that the peak value σₚₑₐₖ² falls within the variance setting range, and that the time-series data y(i) in the steady section falls within a signal setting range determined to include a command value corresponding to the step input signal.

10. The response time evaluation method according to claim 4, wherein, in the step (C), a smoothing section length, which is a length of the smoothing section, is optimized such that the peak value σₚₑₐₖ² falls within the variance setting range, and that the time-series data y(i) in the steady section falls within a signal setting range determined to include a command value corresponding to the step input signal.
